(19) United States
(12) Patent Application Publication
(10) Pub. No.: US 2015/0277297 A1
(43) Pub. Date: Oct. 1, 2015

(54) IMAGE FORMING APPARATUS AND BELT DEVICE

(71) Applicant: FUJI XEROX CO., LTD., Tokyo (JP)

(72) Inventors: Yuichi FUJISAWA, Kanagawa (JP); Kazuyoshi HAGIWARA, Kanagawa (JP); Arichika TANAKA, Kanagawa (JP)

(21) Appl. No.: 14/643,605

(22) Filed: Mar. 10, 2015

(30) Foreign Application Priority Data
Mar. 31, 2014 (JP) 2014-073352

(51) Int. Cl. G03G 15/01

(52) U.S. Cl. CPC G03G 15/1605

(57) ABSTRACT

An image forming apparatus includes an image bearing member that bears an image, a transfer belt that is constituted of an endless belt member and onto which the image on the image bearing member is transferred, and multiple roller members around which the transfer belt is rotatably wrapped. The multiple roller members include a drive roller that rotationally drives the transfer belt and a tilt changeable roller that is capable of changing a tilt angle thereof. An area of the tilt changeable roller that is in contact with the belt member is provided with a contact portion composed of rubber with a coefficient of static friction selected from a range between 0.7 and 1.3.

### CROSS-REFERENCE TO RELATED APPLICATIONS

This application is based on and claims priority under 35 USC 119 from Japanese Patent Application No. 2014-073352 filed Mar. 31, 2014.

### BACKGROUND

### Technical Field

The present invention relates to image forming apparatuses and belt devices.

### SUMMARY

According to an aspect of the invention, there is provided an image forming apparatus including an image bearing member that bears an image, a transfer belt that is constituted of an endless belt member and onto which the image on the image bearing member is transferred, and multiple roller members around which the transfer belt is rotatably wrapped. The multiple roller members include a drive roller that rotationally drives the transfer belt and a tilt changeable roller that is capable of changing a tilt angle thereof. An area of the tilt changeable roller that is in contact with the belt member is provided with a contact portion composed of rubber with a coefficient of static friction selected from a range between 0.7 and 1.3.

### BRIEF DESCRIPTION OF THE DRAWINGS

An exemplary embodiment of the present invention will be described in detail based on the following figures, wherein:

FIG. 1 is a front view illustrating the overall configuration of an image forming apparatus according to an exemplary embodiment;

FIG. 2 is a perspective view of a transfer unit, as viewed from the front;

FIG. 3 is a rear view of a steering roller in the transfer unit and its surroundings;

FIG. 4 illustrates the transfer unit, as viewed from a direction indicated by an arrow IV shown in FIG. 3;

FIG. 5 illustrates the characteristics and evaluation results of samples of steering rollers used in tests; and

FIGS. 6A to 6C each illustrate the relationship between the position of an intermediate transfer belt in a first scanning direction and the amount of irregularities occurring in the intermediate transfer belt as a result of steering operation performed using a steering roller.

### DETAILED DESCRIPTION

An exemplary embodiment of the present invention will be described in detail below with reference to the appended drawings.

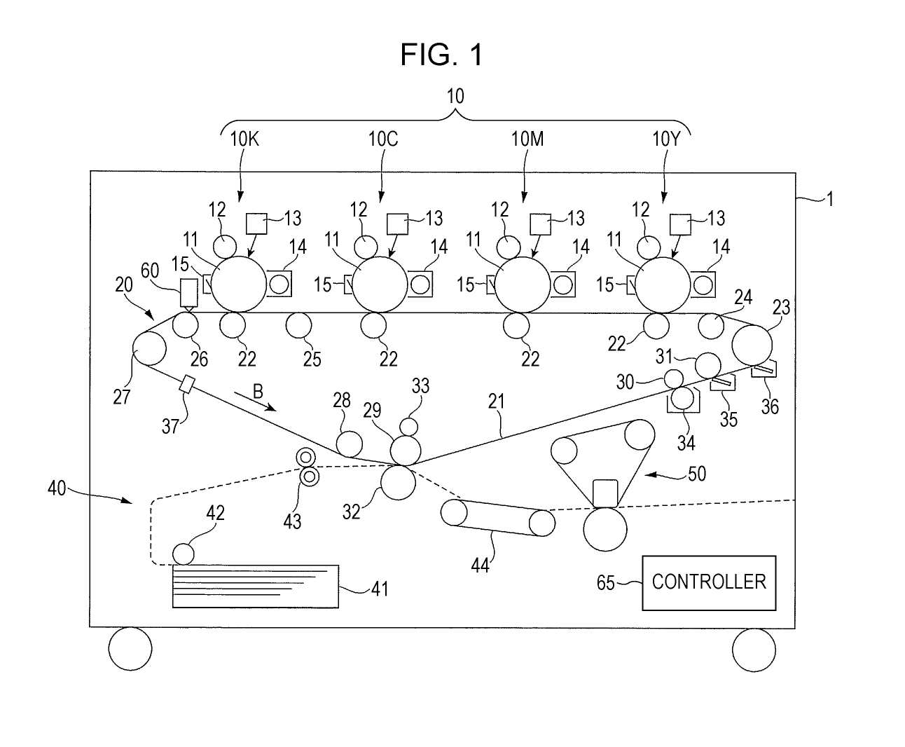

FIG. 1 is a front view illustrating the overall configuration of an image forming apparatus according to an exemplary embodiment.

The image forming apparatus is of a tandem type and an intermediate transfer type and includes an image forming section 10 that forms toner images (i.e., images) of respective colors (i.e., four colors in this example), and a transfer unit 20 having an intermediate transfer belt 21 onto which the toner images of the respective colors formed at the image forming section 10 are first-transferred. The image forming apparatus further includes a sheet transport section 40 that transports a sheet onto which the toner images first-transferred on the intermediate transfer belt 21 are to be second-transferred, a fixing section 50 that fixes the toner images second-transferred on the sheet from the intermediate transfer belt 21, and an image detection sensor 60 that detects the toner images first-transferred on the intermediate transfer belt 21. Moreover, the image forming apparatus further includes a controller 65 that controls the operation of each section constituting the image forming apparatus, and a housing 1 that accommodates therein the image forming section 10, the transfer unit 20, the sheet transport section 40, the fixing section 50, the image detection sensor 60, and the controller 65.

The image forming section 10 has a yellow-image forming unit 10Y that forms a yellow toner image, a magenta-image forming unit 10M that forms a magenta toner image, a cyan-image forming unit 10C that forms a cyan toner image, and a black-image forming unit 10K that forms a black toner image. For example, the yellow-image forming unit 10Y includes a photoconductor drum 11 as an example of an image bearing member that rotates in a direction indicated by an arrow A, a charging device 12 that electrostatically charges the photoconductor drum 11, an exposure device 13 that forms an electrostatic latent image by selectively exposing the electrostatically-charged photoconductor drum 11 to light, a developing device 14 that develops the electrostatic latent image formed on the photoconductor drum 11 by using yellow toner, and a drum cleaning device 15 that cleans the photoconductor drum 11 after a first-transfer process by removing, for example, residual toner therefrom. Except for the colors of toners used, the magenta-image forming unit 10M, the cyan-image forming unit 10C, and the black-image forming unit 10K have configurations identical to the configuration of the yellow-image forming unit 10Y. The four photoconductor drums 11 provided in the image forming section 10 are connected to ground.

The transfer unit 20 includes the intermediate transfer belt 21 as an example of an endless belt member disposed facing the four photoconductor drums 11 provided in the image forming section 10, and four first-transfer rollers 22 disposed facing the respective photoconductor drums 11 with the intermediate transfer belt 21 interposed therebetween. The transfer unit 20 further includes a drive roller 23, a retraction roller 24, an idler roller 25, a sensor facing roller 26, a steering roller 27, a pre-roller 28, a backup roller 29, a brush facing roller 30, and a blade facing roller 31. These rollers and the four first-transfer rollers 22 have the intermediate transfer belt 21 rotatably wrapped therearound.

In this example, the intermediate transfer belt 21 is composed of resin, such as polyimide, and rotates in a direction indicated by an arrow B. The yellow-image forming unit 10Y, the magenta-image forming unit 10M, the cyan-image forming unit 10C, and the black-image forming unit 10K are arranged relative to the intermediate transfer belt 21 in this order in the direction of the arrow B. Therefore, the first-transfer rollers 22 for the respective colors are also arranged in the above order in the direction of the arrow B.

The four first-transfer rollers 22 are disposed in contact with the inner peripheral surface of the intermediate transfer belt 21 at positions corresponding to the yellow-image forming unit 10Y, the magenta-image forming unit 10M, the cyan-image forming unit 10C, and the black-image forming unit 10K, respectively. The four first-transfer rollers 22 are provided with springs (not shown) so as to be pressed toward the corresponding photoconductor drums 11. Each of the four first-transfer rollers 22 is supplied with first-transfer bias for first-transferring the toner image formed on the corresponding photoconductor drum 11 onto the intermediate transfer belt 21.

The drive roller 23 is disposed in contact with the inner peripheral surface of the intermediate transfer belt 21 at the downstream side of the blade facing roller 31 and the upstream side of the retraction roller 24 in the direction of the arrow B. The drive roller 23 rotationally drives the intermediate transfer belt 21 by receiving a drive force from a motor (not shown).

The retraction roller 24 is disposed in contact with the inner peripheral surface of the intermediate transfer belt 21 at the downstream side of the drive roller 23 and the upstream side of the first-transfer roller 22 for the yellow-image forming unit 10Y in the direction of the arrow B. The retraction roller 24 rotates by receiving a drive force from the intermediate transfer belt 21.

The idler roller 25 is disposed in contact with the inner peripheral surface of the intermediate transfer belt 21 at the downstream side of the first-transfer roller 22 for the cyan-image forming unit 10C and the upstream side of the first-transfer roller 22 for the black-image forming unit 10K in the direction of the arrow B. The idler roller 25 rotates by receiving a drive force from the intermediate transfer belt 21.

The sensor facing roller 26 is disposed in contact with the inner peripheral surface of the intermediate transfer belt 21 at the downstream side of the first-transfer roller 22 for the black-image forming unit 10K and the upstream side of the steering roller 27 in the direction of the arrow B. The sensor facing roller 26 rotates by receiving a drive force from the intermediate transfer belt 21. The aforementioned image detection sensor 60 is disposed at a position where it faces the sensor facing roller 26 with the intermediate transfer belt 21 interposed therebetween. However, an image detection position of the image detection sensor 60 as an example of an image detector on the intermediate transfer belt 21 is located away from a position where the intermediate transfer belt 21 and the sensor facing roller 26 start to come into contact with each other by 3 mm upstream in the direction of the arrow B.

The steering roller 27 as an example of a tilt changeable roller is disposed in contact with the inner peripheral surface of the intermediate transfer belt 21 at the downstream side of the sensor facing roller 26 and the upstream side of the pre-roller 28 in the direction of the arrow B. The steering roller 27 rotates by receiving a drive force from the intermediate transfer belt 21. Furthermore, the steering roller 27 has a function for applying tension to the intermediate transfer belt 21 wrapped around the multiple rollers and a function for correcting meandering of the intermediate transfer belt 21 rotating in the direction of the arrow B. The steering roller 27 will be described in detail later.

The pre-roller 28 is disposed in contact with the inner peripheral surface of the intermediate transfer belt 21 at the downstream side of the steering roller 27 and the upstream side of the backup roller 29 in the direction of the arrow B. The pre-roller 28 rotates by receiving a drive force from the intermediate transfer belt 21.

The backup roller 29 is disposed in contact with the inner peripheral surface of the intermediate transfer belt 21 at the downstream side of the pre-roller 28 and the upstream side of the brush facing roller 30 in the direction of the arrow B. The backup roller 29 rotates by receiving a drive force from the intermediate transfer belt 21.

The brush facing roller 30 is disposed in contact with the inner peripheral surface of the intermediate transfer belt 21 at the downstream side of the backup roller 29 and the upstream side of the blade facing roller 31 in the direction of the arrow B. The brush facing roller 30 rotates by receiving a drive force from the intermediate transfer belt 21.

The blade facing roller 31 is disposed in contact with the inner peripheral surface of the intermediate transfer belt 21 at the downstream side of the brush facing roller 30 and the upstream side of the drive roller 23 in the direction of the arrow B. The blade facing roller 31 rotates by receiving a drive force from the intermediate transfer belt 21.

In this exemplary embodiment, the drive roller 23, the retraction roller 24, the idler roller 25, the sensor facing roller 26, the steering roller 27, the pre-roller 28, the backup roller 29, the brush facing roller 30, and the blade facing roller 31 function as multiple roller members.

In this exemplary embodiment, of the retraction roller 24, the idler roller 25, and the sensor facing roller 26 that support the intermediate transfer belt 21 near the image forming section 10, the idler roller 25 and the sensor facing roller 26 are positionally fixed, whereas the retraction roller 24 is positionally movable in the vertical direction in FIG. 1. When a full-color image is to be formed by using yellow, magenta, cyan, and black toners, the retraction roller 24 is moved to the position shown in FIG. 1 so as to set the four photoconductor drums 11 in contact with the intermediate transfer belt 21. In contrast, when a monochrome image is to be formed by using the black toner alone, the retraction roller 24 is moved downward away from the position shown in FIG. 1 so as to set the black photoconductor drum 11 in contact with the intermediate transfer belt 21 but to set the yellow, magenta, and cyan photoconductor drums 11 out of contact with the intermediate transfer belt 21. In this case, the yellow, magenta, and cyan first-transfer rollers 22 move downward as a result of receiving a force from the intermediate transfer belt 21, and the steering roller 27 applies tension to the intermediate transfer belt 21 so that the intermediate transfer belt 21 does not sag.

The transfer unit 20 further includes a second-transfer roller 32, a feeder roller 33, a cleaning brush 34, a cleaning blade 35, a scraper 36, and a belt-edge detection sensor 37.

The second-transfer roller 32 is disposed in contact with the outer peripheral surface of the intermediate transfer belt 21 at a position where the second-transfer roller 32 faces the backup roller 29 with the intermediate transfer belt 21 interposed therebetween. The second-transfer roller 32 rotates by receiving a drive force from the intermediate transfer belt 21.

The feeder roller 33 is disposed in contact with the backup roller 29 at the inner peripheral side of the intermediate transfer belt 21. The feeder roller 33 rotates by receiving a drive force from the backup roller 29.

In this exemplary embodiment, the second-transfer roller 32, the backup roller 29, and the feeder roller 33 constitute a second-transfer unit for second-transferring a toner image or toner images first-transferred on the intermediate transfer belt 21 onto a sheet. In the second-transfer unit, the second-transfer roller 32 is connected to ground, and the backup roller 29 is supplied with second-transfer bias via the feeder roller 33.

The cleaning brush 34 is disposed in contact with the outer peripheral surface of the intermediate transfer belt 21 at a position where the cleaning brush 34 faces the brush facing roller 30 with the intermediate transfer belt 21 interposed therebetween. In a contact region between the cleaning brush 34 and the intermediate transfer belt 21, the cleaning brush 34 rotates in a direction opposite to the direction of the arrow B by receiving a drive force from the outside.

The cleaning blade 35 is disposed in contact with the outer peripheral surface of the intermediate transfer belt 21 at a position where the cleaning blade 35 faces the blade facing roller 31 with the intermediate transfer belt 21 interposed therebetween.

The scraper 36 is disposed in contact with the outer peripheral surface of the intermediate transfer belt 21 at a position where the scraper 36 faces the drive roller 23 with the intermediate transfer belt 21 interposed therebetween.

In this exemplary embodiment, the cleaning brush 34, the cleaning blade 35, and the scraper 36 constitute a belt cleaning device that cleans the intermediate transfer belt 21 after a second-transfer process by removing, for example, residual toner therefrom.

The belt-edge detection sensor 37 as an example of a side-edge detector is disposed at a side edge (at the front edge in this example) of the intermediate transfer belt 21 at the downstream side of the steering roller 27 and the upstream side of the pre-roller 28 in the direction of the arrow B. The belt-edge detection sensor 37 detects the position of the front edge of the intermediate transfer belt 21 moving in the direction of the arrow B.

In this exemplary embodiment, the transfer unit 20 is detachable from the housing 1 such that the transfer unit 20 is replaceable relative to the image forming apparatus. The configuration of the transfer unit 20 will be described later.

The sheet transport section 40 includes a sheet accommodation portion 41 that accommodates a sheet, a sheet feed roller 42 that feeds the sheet accommodated in the sheet accommodation portion 41, a registration roller 43 that transports the sheet fed by the sheet feed roller 42 toward the second-transfer unit while correcting the registration of the sheet, and a sheet transport belt 44 that transports the sheet passed through the second-transfer unit toward the fixing section 50. The sheet transport section 40 includes multiple transport rollers (not shown) provided in a transport path extending from the sheet accommodation portion 41 toward the outside of the housing 1 (i.e., outside of the apparatus) via the second-transfer unit and the fixing section 50.

Next, image forming operation performed using the image forming apparatus shown in FIG. 1 will be described. The following description relates to an example in which the image forming apparatus is set in the state shown in FIG. 1 so as to form a full-color image.

For example, in the yellow-image forming unit 10Y in the image forming section 10, the photoconductor drum 11 rotating in the direction of the arrow A is electrostatically charged by the charging device 12. Then, the exposure device 13 performs an exposure process so that the electrostatically-charged photoconductor drum 11 rotating in the direction of the arrow A is selectively exposed to light emitted from the exposure device 13, whereby a yellow electrostatic latent image is formed on the photoconductor drum 11.

Subsequently, the yellow electrostatic latent image formed on the photoconductor drum 11 passes through a region where the photoconductor drum 11 and the developing device 14 face each other as the photoconductor drum 11 rotates in the direction of the arrow A, whereby a yellow toner image corresponding to the electrostatic latent image is formed on the photoconductor drum 11. Then, as the photoconductor drum 11 rotates in the direction of the arrow A, the toner image formed on the photoconductor drum 11 reaches a first-transfer position where the photoconductor drum 11 faces the corresponding first-transfer roller 22 with the intermediate transfer belt 21 interposed therebetween. In this case, since the photoconductor drum 11 is connected to ground and the first-transfer roller 22 is supplied with first-transfer bias, the yellow toner image formed on the photoconductor drum 11 rotating in the direction of the arrow A is first-transferred (electrostatically-transferred) onto the intermediate transfer belt 21 rotating in the direction of the arrow B. As the photoconductor drum 11 further rotates in the direction of the arrow A, for example, residual toner remaining on the photoconductor drum 11 after the first-transfer process reaches a region where the photoconductor drum 11 faces the drum cleaning device 15, whereby the photoconductor drum 11 is cleaned by the drum cleaning device 15.

The magenta-image forming unit 10M, the cyan-image forming unit 10C, and the black-image forming unit 10K undergo the charging process, the exposure process, the first-transfer process, and the cleaning process in a manner similar to the yellow-image forming unit 10Y. In this case, the image formation timing is varied among the units so that a superimposed toner image obtained by superimposing the yellow, magenta, cyan, and black toner images is formed on the intermediate transfer belt 21.

As the intermediate transfer belt 21 rotates in the direction of the arrow B, the superimposed toner image first-transferred on the intermediate transfer belt 21 in this manner moves toward a second-transfer position where the second-transfer roller 32 and the backup roller 29 face each other with the intermediate transfer belt 21 interposed therebetween.

On the other hand, the sheet fed by the sheet feed roller 42 from the sheet accommodation portion 41 is transported toward the second-transfer position by the registration roller 43 in accordance with a timing at which the superimposed toner image on the intermediate transfer belt 21 reaches the second-transfer position.

In this case, at the second-transfer position, the second-transfer roller 32 constituting the second-transfer unit is connected to ground, and the backup roller 29 is supplied with second-transfer bias via the feeder roller 33. Then, at the second-transfer position, the superimposed toner image on the intermediate transfer belt 21 becomes second-transferred (electrostatically-transferred) onto the sheet due to the effect of a second-transfer electric field generated between the second-transfer roller 32 and the backup roller 29.

Subsequently, the sheet having the superimposed toner image second-transferred thereon is transported to the fixing section 50 by the sheet transport belt 44. The superimposed toner image on the sheet is fixed thereon by being heated and pressed by the fixing section 50, and is subsequently output outside the image forming apparatus. As the intermediate transfer belt 21 further rotates in the direction of the arrow B, for example, residual toner remaining on the intermediate transfer belt 21 after the second-transfer process sequentially pass through regions where the intermediate transfer belt 21 faces the cleaning brush 34, the cleaning blade 35, and the scraper 36 constituting the belt cleaning device, whereby the intermediate transfer belt 21 is cleaned.

While the image forming operation is performed in this manner, the belt-edge detection sensor 37 detects the position of the front edge of the intermediate transfer belt 21 rotating in the direction of the arrow B and outputs the obtained detection result to the controller 65. Based on the detection result input from the belt-edge detection sensor 37, the controller 65 controls the tilt angle of the steering roller 27 that supports the intermediate transfer belt 21 so as to correct the meandering of the intermediate transfer belt 21.

In the image forming apparatus according to this exemplary embodiment, misregistration among the yellow, magenta, cyan, and black toner images on the intermediate transfer belt 21 (i.e., misregistration in a first scanning direction and misregistration in a second scanning direction) or a density variation among the toner images may occur. Therefore, in this image forming apparatus, before or during the image forming operation, a toner image used for adjusting misregistration among the toner images or a toner image used for adjusting a density variation among the toner images (which will collectively be referred to as “adjustment toner image” hereinafter) is formed on the intermediate transfer belt 21 by using the image forming section 10. Based on a read result obtained by the image detection sensor 60 reading this adjustment toner image, the controller 65 performs timing control or density control on the yellow-image forming unit 10Y, the magenta-image forming unit 10M, the cyan-image forming unit 10C, and the black-image forming unit 10K.

Next, the transfer unit 20 provided in the image forming apparatus will be described.

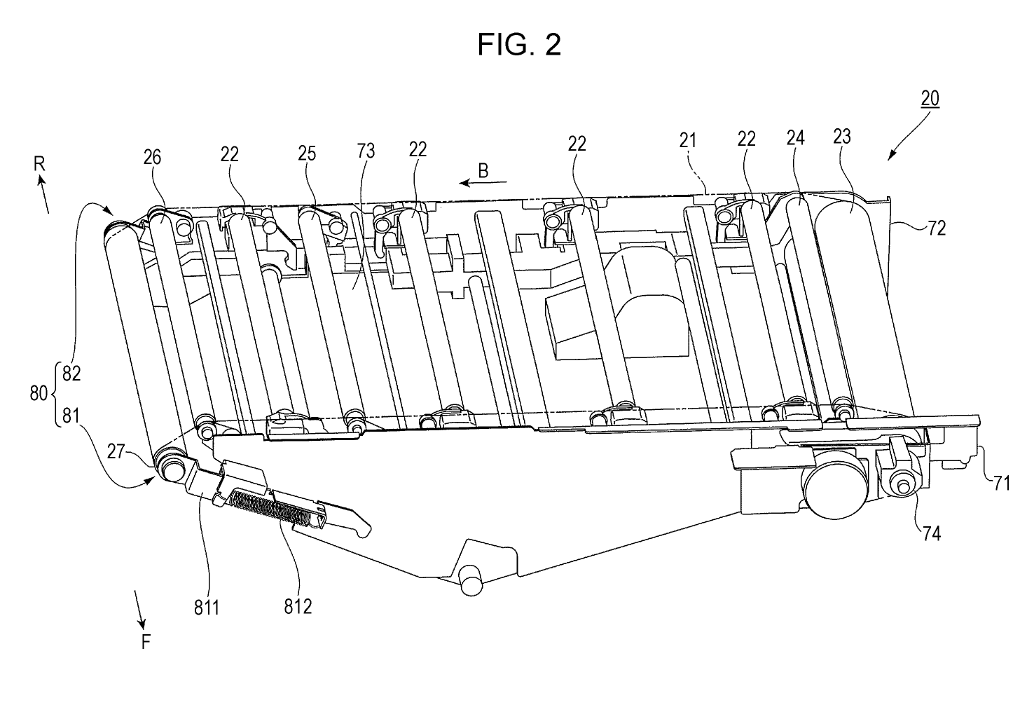

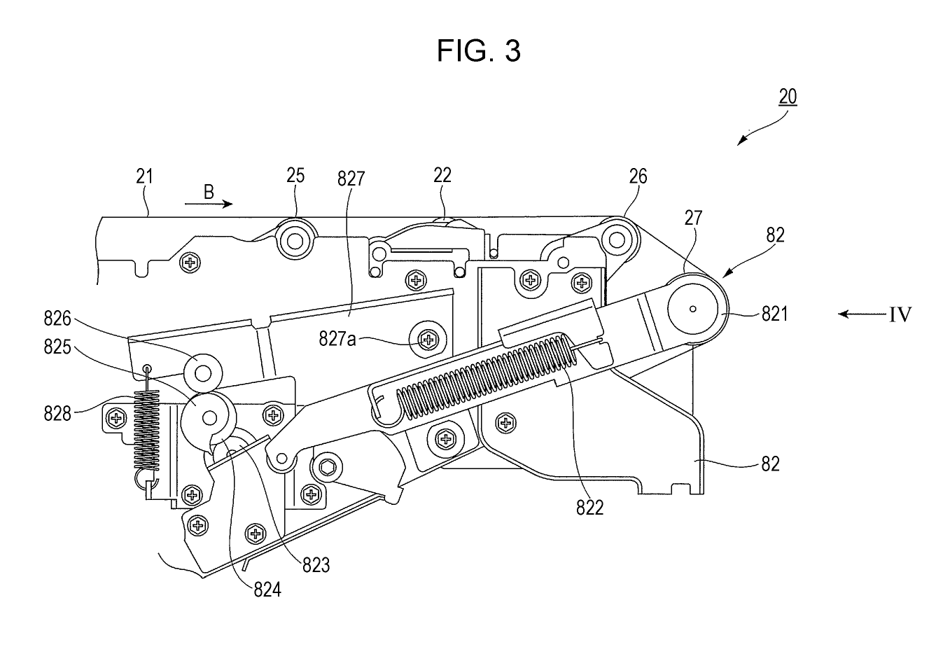

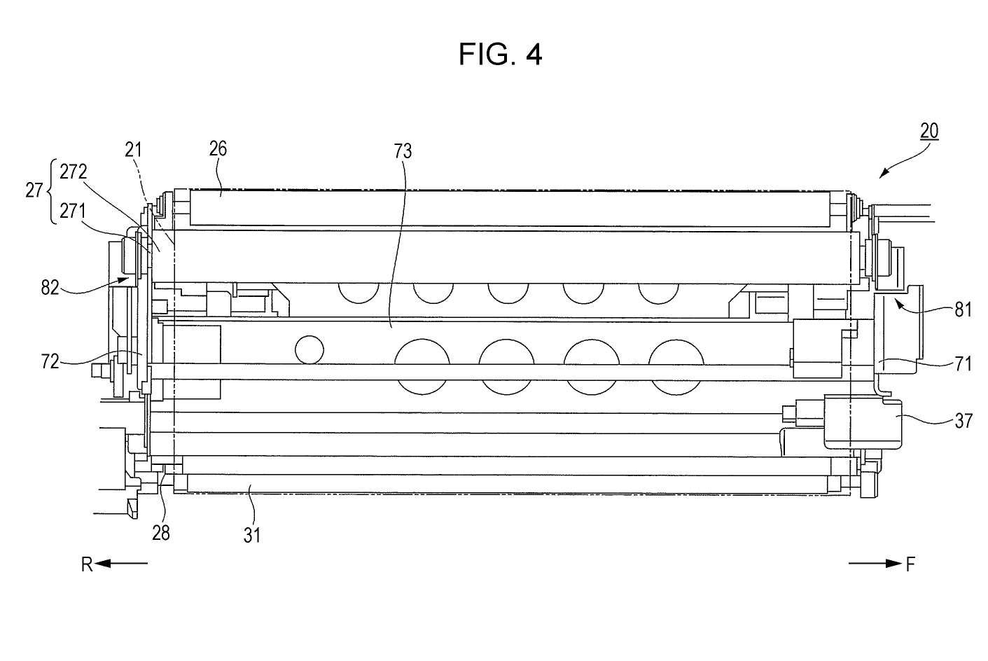

FIG. 2 is a perspective view of the transfer unit 20, as viewed from a front F side. FIG. 3 illustrates the steering roller 27 in the transfer unit 20 and its surroundings, as viewed from a rear R side. FIG. 4 illustrates the transfer unit 20, as viewed from a direction indicated by an arrow IV shown in FIG. 3.

The transfer unit 20 according to this exemplary embodiment includes a front frame 71, a rear frame 72, and a connection frame 73. The front frame 71 is provided at the front F side, as viewed from the intermediate transfer belt 21, and supports the front F side of the components constituting the transfer unit 20. The rear frame 72 is provided at the rear R side, as viewed from the intermediate transfer belt 21, and supports the rear R side of the components constituting the transfer unit 20. The connection frame 73 connects the front frame 71 and the rear frame 72. The transfer unit 20 further includes a belt motor 74 that rotationally drives the drive roller 23, and a mechanism (not shown) for positionally moving the retraction roller 24.

The transfer unit 20 further includes a supporter 80. The supporter 80 has a front-side supporter 81 that supports the front F side of the steering roller 27 at the front frame 71, and a rear-side supporter 82 that supports the rear R side of the steering roller 27 at the rear frame 72.

The front-side supporter 81 has a front-side arm 811 whose first end rotatably supports the front F side of the steering roller 27 and whose second end is movable toward and away from the front frame 71, and a front-side spring 812 whose first end is attached to the front frame 71 and whose second end is attached to the front-side arm 811 so as to press the front F side of the steering roller 27 against the inner peripheral surface of the intermediate transfer belt 21.

The rear-side supporter 82 has a rear-side arm 821 whose first end rotatably supports the rear R side of the steering roller 27 and whose second end is movable toward and away from the rear frame 72 and is also pivotable relative thereto, and a rear-side spring 822 whose first end is attached to the rear frame 72 and whose second end is attached to the rear-side arm 821 so as to press the rear R side of the steering roller 27 against the inner peripheral surface of the intermediate transfer belt 21. Furthermore, the rear-side supporter 82 also has a first gear 823 attached to a rotation shaft of an arm motor (not shown) for pivoting the rear-side arm 821, a second gear 824 attached so as to mesh with the first gear 823, and a cam 825 integrated with the second gear 824. The first gear 823, the second gear 824, and the cam 825 are attached to fixed positions of the rear frame 72. Moreover, the rear-side supporter 82 also has a cam follower 826 disposed at a position where it is in contact with a cam surface of the cam 825, a lever 827 that is supported by the rear frame 72 in a rotatable manner about a fulcrum 827a and to which the second end of the rear-side arm 821 and the cam follower 826 are attached, and a spring 828 whose first end is attached to the lever 827 and whose second end is attached to the rear frame 72 so as to press the cam follower 826 against the cam 825.

In this exemplary embodiment, the steering roller 27 is pressed against the inner peripheral surface of the intermediate transfer belt 21 via the front-side spring 812 and the front-side arm 811 and is also pressed against the inner peripheral surface of the intermediate transfer belt 21 via the rear-side spring 822 and the rear-side arm 821, so that predetermined tension is applied to the intermediate transfer belt 21 wrapped around the multiple rollers.

Furthermore, in this exemplary embodiment, in a state where the front F side of the steering roller 27 is positionally fixed by using the front-side supporter 81, the position of the rear R side of the steering roller 27 is changed by using the rear-side supporter 82 so that the tilt angle of the steering roller 27 is varied relative to a direction intersecting the rotational direction (i.e., the direction of the arrow B) of the intermediate transfer belt 21, thereby correcting the meandering of the intermediate transfer belt 21 while rotating the intermediate transfer belt 21.

The relationship between the steering roller 27 and the intermediate transfer belt 21 in the case where the meandering of the intermediate transfer belt 21 is corrected by tilting the steering roller 27, as in this exemplary embodiment, will now be discussed. For example, in a configuration in which the intermediate transfer belt 21 is highly slidable against the steering roller 27, the trackability of the intermediate transfer belt 21 relative to the tilting of the steering roller 27 is insufficient, thus making it difficult to correct the meandering of the intermediate transfer belt 21. On the other hand, for example, in a configuration in which the slidability of the intermediate transfer belt 21 relative to the steering roller 27 is low, the meandering of the intermediate transfer belt 21 may be readily corrected, but an undulant wrinkle, called a tension line, extending in the direction of the arrow B tends to occur in the intermediate transfer belt 21 before and after the steering roller 27 (i.e., the upstream and downstream sides thereof in the direction of the arrow B). Such a tension line occurs as a result of torsion applied to the intermediate transfer belt 21. When such a tension line occurs in the intermediate transfer belt 21, the shape of the intermediate transfer belt 21, and by extension the transfer performance thereof, may be adversely affected at, for example, the first-transfer positions and the second-transfer position, and the lifespan of the intermediate transfer belt 21 may also be adversely affected.

Furthermore, in the image forming apparatus according to this exemplary embodiment, the image detection sensor 60 is disposed facing the intermediate transfer belt 21 in the vicinity of the sensor facing roller 26 disposed adjacent to the steering roller 27. Therefore, if a tension line occurring in the intermediate transfer belt 21 as a result of tilting the steering roller 27 reaches the image read position of the image detection sensor 60, the adjustment-toner-image read result obtained by the image detection sensor 60 may also be adversely affected. In other words, an error included in the read result may become large, possibly resulting in reduced accuracy for the timing control and the density control in the image forming section 10.

In this exemplary embodiment, a function for correcting the meandering of the intermediate transfer belt 21 and a function for suppressing a tension line in the intermediate transfer belt 21 are both achieved by selecting an appropriate material and an appropriate coefficient of static friction for the steering roller 27.

The configuration of the steering roller 27 will now be described.

The steering roller 27 according to this exemplary embodiment is rod-shaped and includes a shaft 271 whose front F end and rear R end are rotatably supported by the front-side arm 811 and the rear-side arm 821, respectively, and a cylindrical roller body 272 that is wrapped around the shaft 271 and whose outer peripheral surface is in contact with the inner peripheral surface of the intermediate transfer belt 21.

The shaft 271 is composed of a metallic material, such as stainless steel.

On the other hand, the roller body 272 as an example of a contact portion is composed of a rubber material with a coefficient of static friction ranging between 0.7 and 1.3 in its entirety. The width of the roller body 272 (i.e., the length thereof in the direction intersecting the rotational direction (the direction of the arrow B) of the intermediate transfer belt 21) is set to be larger than the width of the intermediate transfer belt 21. In this exemplary embodiment, the rubber material used for the roller body 272 is ethylene-propylene-diene methylene linkage (EPDM). Alternatively, the rubber material used for the roller body 272 may be, for example, nitrile rubber (NBR).

In this exemplary embodiment, the roller body 272 constituting the steering roller 27 is composed of a rubber material with a coefficient of static friction of 0.7 or higher, so that the trackability of the intermediate transfer belt 21 relative to the tilting of the steering roller 27 may be enhanced, whereby the meandering of the intermediate transfer belt 21 may be readily corrected. Furthermore, in this exemplary embodiment, the roller body 272 constituting the steering roller 27 is composed of a rubber material with a coefficient of static friction of 1.3 or lower, so that the occurrence of a tension line in the intermediate transfer belt 21 may be suppressed when the steering roller 27 is tilted, whereby a transfer defect and reduced lifespan of the intermediate transfer belt 21 may be suppressed. Furthermore, with the ability to suppress the occurrence of a tension line in the intermediate transfer belt 21, an error in the adjustment-toner-image read result obtained by the image detection sensor 60 may be reduced, whereby reduction in the accuracy for the timing control and the density control in the image forming section 10 may be suppressed.

Various kinds of tests performed by the present inventor will now be described.

Four samples of steering rollers 27 with roller bodies 272 composed of different materials (i.e., different coefficients of static friction) are prepared by the present inventor. Then, in a state where the sample of each steering roller 27 is attached to the image forming apparatus shown in FIG. 1, the intermediate transfer belt 21 is rotationally driven, and meandering control of the intermediate transfer belt 21 is performed by using the belt-edge detection sensor 37 and the steering roller 27. With regard to the sample of each steering roller 27, the function thereof for correcting the meandering of the intermediate transfer belt 21 and the function thereof for suppressing a tension line occurring in the intermediate transfer belt 21 during the meandering correction are evaluated.

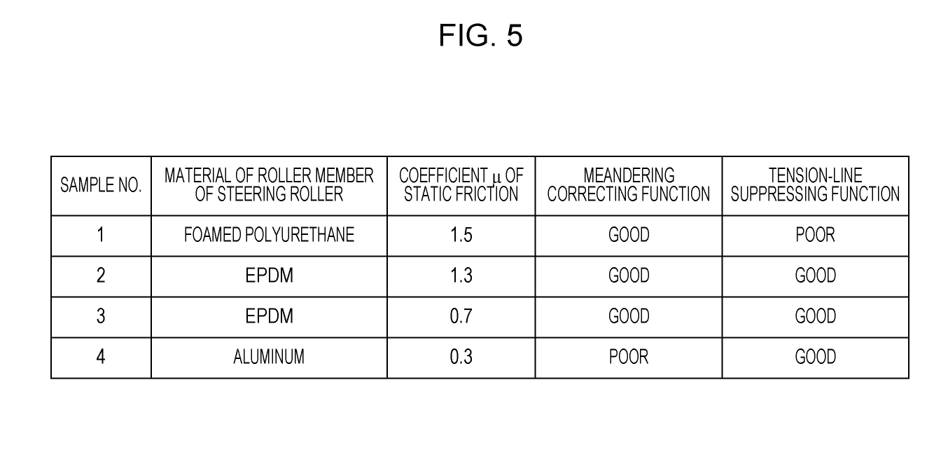

FIG. 5 illustrates the characteristics and evaluation results of the samples of the steering rollers 27 used in the tests.

In the steering roller 27 of sample No. 1, the roller body 272 is composed of foamed polyurethane. A coefficient μ of static friction of the roller body 272 (foamed polyurethane) in sample No. 1 is 1.5.

In the steering roller 27 of sample No. 2, the roller body 272 is composed of EPDM. The coefficient μ of static friction of the roller body 272 (EPDM) in sample No. 2 is 1.3.

In the steering roller 27 of sample No. 3, the roller body 272 is composed of EPDM. The coefficient μ of static friction of the roller body 272 (EPDM) in sample No. 3 is 0.7.

In the steering roller 27 of sample No. 4, the roller body 272 is composed of aluminum. The coefficient μ of static friction of the roller body 272 (aluminum) in sample No. 4 is 0.3.

In each of samples Nos. 1 to 4, the shaft 271 is composed of stainless steel.

Next, the evaluation standard in each test will be described.

First, with reference to the meandering correcting function of sample No. 1 in which the coefficient μ of static friction is the highest among the samples, a sample having a meandering correcting function equivalent to that of sample No. 1 is given the evaluation result “good”, whereas a sample having a meandering correcting function poorer than that of sample No. 1 is given the evaluation result “poor”.

With reference to the tension-line suppressing function of sample No. 4 in which the coefficient μ of static friction is the lowest among the samples, a sample having a tension-line suppressing function equivalent to that of sample No. 4 is given the evaluation result “good”, whereas a sample having a tension-line suppressing function poorer than that of sample No. 4 is given the evaluation result “poor”.

With regard to the meandering correcting function, samples Nos. 1, 2, and 3 are given the evaluation result “good”, whereas sample No. 4 is given the evaluation result “poor”, as shown in FIG. 5. Accordingly, with regard to the meandering correcting function, the evaluation result “good” is obtained when the coefficient μ of static friction ranges between 0.7 and 1.5.

With regard to the tension-line suppressing function, samples Nos. 2, 3, and 4 are given the evaluation result “good”, whereas sample No. 1 is given the evaluation result “poor”, as shown in FIG. 5. Accordingly, with regard to the tension-line suppressing function, the evaluation result “good” is obtained when the coefficient μ of static friction ranges between 0.3 and 1.3.

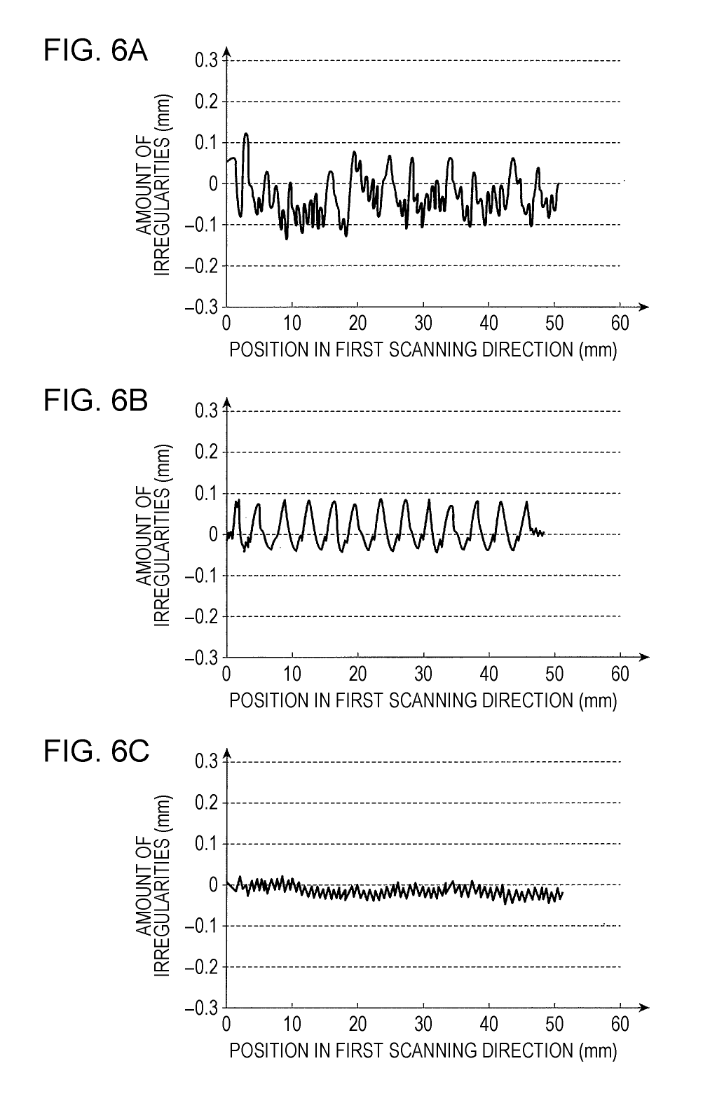

FIGS. 6A to 6C illustrate examples of test results related to the tension-line suppressing function. More specifically, FIGS. 6A to 6C each illustrate the relationship between the position of the intermediate transfer belt 21 in the first scanning direction and the amount of irregularities occurring in the intermediate transfer belt 21 as a result of steering operation performed using the steering roller 27. FIG. 6A illustrates a result corresponding to when the steering roller 27 of sample No. 1 is used, FIG. 6B illustrates a result corresponding to when the steering roller 27 of sample No. 2 is used, and FIG. 6C illustrates a result corresponding to when the steering roller 27 of sample No. 4 is used. The magnitude of irregularities occurring in the intermediate transfer belt 21 corresponds to the magnitude of a tension line.

It is apparent from FIG. 6A that, in sample No. 1, the amount of irregularities occurring in the intermediate transfer belt 21 as a result of the steering operation is 0.1 mm or larger at maximum. In contrast, it is apparent that, in samples Nos. 2 and 4, the amount of irregularities occurring in the intermediate transfer belt 21 as a result of the steering operation is smaller than 0.1 at maximum. Accordingly, by reducing the coefficient μ of static friction of the roller body 272 in the steering roller 27, a tension line is less likely to occur.

Consequently, by using a rubber material (such as EPDM) for the roller body 272 of the steering roller 27 and selecting the coefficient μ of static friction thereof from a range between 0.7 and 1.3, the evaluation result “good” is achieved for both the meandering correcting function and the tension-line suppressing function.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image bearing member that bears an image;
a transfer belt that is constituted of an endless belt member and onto which the image on the image bearing member is transferred; and
a plurality of roller members around which the transfer belt is rotatably wrapped, the plurality of roller members including a drive roller that rotationally drives the transfer belt and a tilt changeable roller that is capable of changing a tilt angle thereof,
wherein an area of the tilt changeable roller that is in contact with the belt member is provided with a contact portion composed of rubber with a coefficient of static friction selected from a range between 0.7 and 1.3.

2. The image forming apparatus according to claim 1, further comprising:
an image detector that is disposed facing an outer peripheral surface of the transfer belt at an upstream side of the tilt changeable roller in a rotational direction of the transfer belt and that detects the image transferred on the transfer belt;
a side-edge detector that is disposed facing a side edge of the transfer belt at a downstream side of the tilt changeable roller in the rotational direction of the transfer belt and that detects a position of the side edge of the transfer belt; and
a controller that controls formation of the image onto the image bearing member based on a detection result obtained by the image detector and that controls the tilt angle of the tilt changeable roller based on a detection result obtained by the side-edge detector.

3. A belt device comprising:
an endless belt member; and
a plurality of roller members around which the belt member is rotatably wrapped, the plurality of roller members including a drive roller that rotationally drives the belt member and a tilt changeable roller that is capable of changing a tilt angle thereof,
wherein an area of the tilt changeable roller that is in contact with the belt member is provided with a contact portion composed of rubber with a coefficient of static friction selected from a range between 0.7 and 1.3.

4. The belt device according to claim 3,
wherein the contact portion in the tilt changeable roller is composed of ethylene-propylene-diene methylene linkage.
